(19) United States
(12) Patent Application Publication
(10) Pub. No.: US 2017/0083344 A1
(43) Pub. Date: Mar. 23, 2017

(54) METHOD FOR AUTOMATICALLY FUNCTIONALLY TRANSFERRING INPUT DEVICE OF PERSONAL COMPUTER TO MOBILE DEVICE

(71) Applicant: I/O INTERCONNECT INC., TAIPEI (TW)

(72) Inventors: Ping-Shun ZEUNG, TAIPEI (TW); Kun-Yuan LIN, TAIPEI (TW)

(21) Appl. No.: 15/366,361

(22) Filed: Dec. 1, 2016

Related U.S. Application Data
(63) Continuation-in-part of application No. 14/607,046, filed on Jan. 27, 2015.

(51) Int. Cl. G06F 9/44; G06F 9/445

(52) U.S. Cl. CPC G06F 9/4411; G06F 8/61

(57) ABSTRACT

A method for transferring an input device of a computer to a mobile device is provided herein. The computer has a first port actuated by a first driver for coupling to the input device. The method includes steps of: (a) detecting whether the mobile device is connected to the computer through a second port, to proceed to step (b) if they are connected, or to repeat step (a) if they are not connected; (b) installing a second driver to substitute for the first driver to control the second port; (C) sending a command to the mobile device to make the computer as an accessory device; (d) transferring the control right of the input device to the mobile device; and (e) getting an input signal through the first port, converting the input signal through the second driver, and sending the converted input signal to the mobile device through the second port.

### RELATED APPLICATIONS

This application is a Continuation-in-part of U.S. application Ser. No. 14/607,046, filed on Jan. 27, 2015, which is incorporated by reference herein.

### BACKGROUND OF THE INVENTION

Field of Invention

The present invention relates to a control right of an input device among a personal computer and a mobile device. More particularly, the present invention relates to a method for automatically functionally transferring an input device of a personal computer to a mobile device.

Description of Related Art

Mobile devices, such as smartphones and tablets, have become an essential for most modern people. Many users of mobile devices like to connect their mobile devices to a personal computer (for example, a desktop or laptop computer) to serve as a second computer. Usually, a personal computer must be equipped with a mouse and a keyboard as input devices. Although most mobile devices are provided with a touchscreen, a mouse and keyboard are still much more convenient then a touchscreen in operation. When a user wants to use a mouse and keyboard of a personal computer to operate his or her mobile device connected to the personal computer, the user must proceed with a series of manual operations. The user cannot directly use the input devices of the personal computer to operate the mobile device without such a series of manual operations. This is not very easy for general users. However, there is no solution in the market yet.

In view of the foregoing, problems and disadvantages are associated with existing products that require further improvement. However, those skilled in the art have yet to find a solution.

### SUMMARY OF THE INVENTION

The following presents a simplified summary of the disclosure in order to provide a basic understanding to the reader. This summary is not an extensive overview of the disclosure and it does not identify key/critical elements of the present invention or delineate the scope of the present invention.

One aspect of the present disclosure is directed to a method for automatically functionally transferring an input device of a personal computer to a mobile device, wherein the personal computer is based on a first OS system and has a plurality of ports actuated by a first driver in the personal computer, wherein at least one of the ports, as a first port, is adapted to electrically couple the input device, wherein the mobile device is based on a second OS system, the method comprising the steps of: (a) detecting whether the mobile device is electrically coupled to the personal computer through one of the ports, as a second port, to proceed to step (b) if the mobile device is electrically coupled to the personal computer, or to repeat step (a) if the mobile device is not electrically coupled to the personal computer; (b) installing a second driver in the personal computer to substitute for the first driver to control the second port; (C) sending a command to the mobile device to make the personal computer as an accessory device for the mobile device based on the second OS system; (d) transferring the control right of the input device from the personal computer to the mobile device; and (e) getting an input signal from the input device through the first port and the first driver, converting the input signal through the second driver, and sending the converted input signal to the mobile device through the second port.

In view of the foregoing, embodiments of the present disclosure provide a method for automatically functionally transferring an input device of a personal computer to a mobile device to improve the problems that the mobile device is hard for users to input information.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1 is a schematic diagram of an arrangement of an input device, a personal computer, and a mobile device according to embodiments of the present invention; and

FIG. 2 is a flow diagram illustrating the process steps of a method for automatically functionally transferring an input device of a personal computer to a mobile device according to embodiments of the present disclosure.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

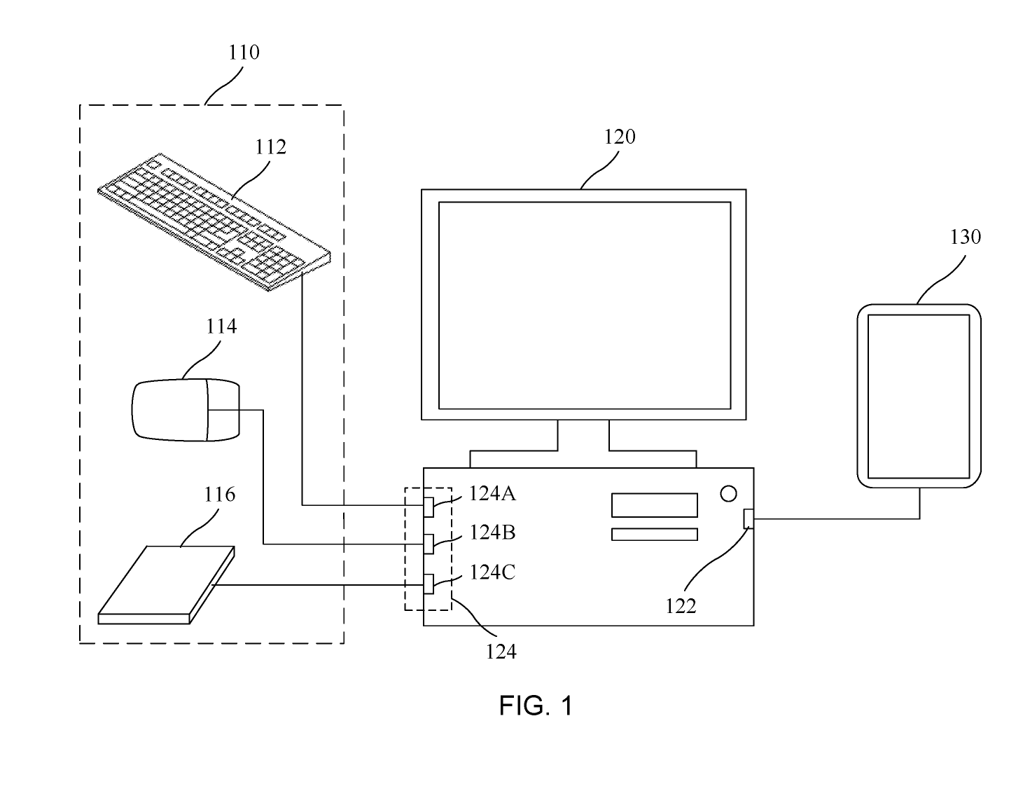

FIG. 1 is a schematic diagram of an arrangement of an input device 110, a personal computer 120, and a mobile device 130 according to embodiments of the present invention. As shown in FIG. 1, the personal computer 120 is based on a first OS system, and the mobile device 130 is based on a second OS system. The personal computer 120 has a plurality of ports 122, 124 actuated by a first driver in the personal computer 120. At least one of the ports, as a first port, is adapted to electrically couple the input device 110.

In an embodiment, the input device 110 can be electrically coupled to the personal computer 120 through the first port 124. In another embodiment, the input device 110 can be but not limited to a keyboard 112, a mouse 114, or a touch pad 116, and the first port 124 may include ports 124A, 124B, 124C for electrically coupling with the keyboard 112, the mouse 114, and the touch pad 116 respectively. In still another embodiment, the ports can be but not limited to USB ports, and the first driver can be but not limited to a standard USB driver correspondingly.

In some embodiments, the keyboard 112, the mouse 114, and the touch pad 116 can be connected to the personal computer 120 in a wired or a wireless manner. In an optional embodiment, the first port 124 can be but not limited to a Bluetooth connection port (not shown) or other wireless connection port for wirelessly connecting with the input device 110.

In an embodiment, the personal computer 120 can be but not limited to a desktop computer or a laptop computer, and the mobile device 130 can be but not limited to a smartphone or a tablet. In another embodiment, the personal computer 120 is based on the first OS system, for example, a Windows™ system, and the mobile device 130 is based on the second OS system, for example, an Android™ system. In yet another embodiment, the mobile device 130 supports Android Open Accessory.

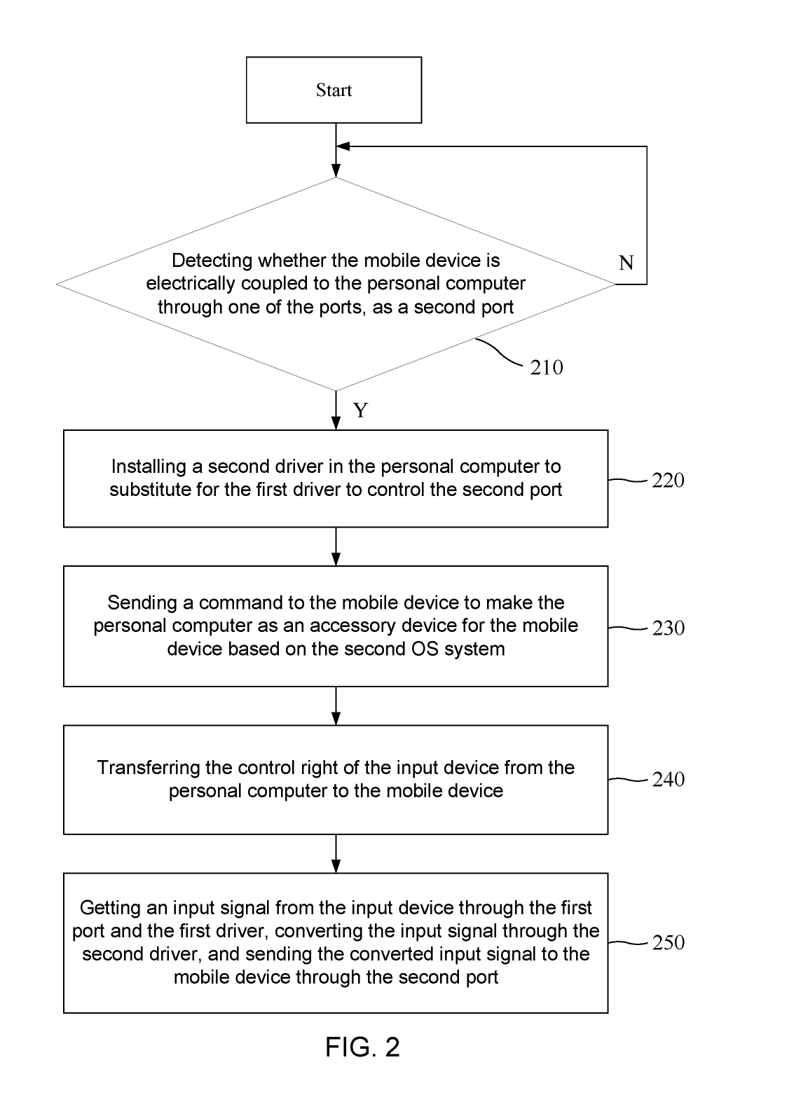

For facilitating the understanding of the method for automatically functionally transferring the input device 110 of the personal computer 120 to the mobile device 130, please referring to FIG. 2, which is a flow diagram illustrating the process steps of the foregoing method according to embodiments of the present disclosure. As shown in FIG. 2, the method 200 comprises steps of:

Step 210: detecting whether the mobile device is electrically coupled to the personal computer through one of the ports, as a second port;

Step 220: installing a second driver in the personal computer to substitute for the first driver to control the second port;

Step 230: sending a command to the mobile device to make the personal computer as an accessory device for the mobile device based on the second OS system;

Step 240: transferring the control right of the input device from the personal computer to the mobile device; and

Step 250: getting an input signal from the input device through the first port and the first driver, converting the input signal through the second driver, and sending the converted input signal to the mobile device through the second port.

Reference is now made to both FIG. 1 and FIG. 2. In step 210, the personal computer 120 is configured to detect whether the mobile device 130 is electrically coupled to the personal computer 120 through one of the ports, as a second port 122. For example, if the mobile device 130 is electrically coupled to the personal computer 120 through the second port 122, the personal computer 120 will detect that they are connected to each other through the second port 122; subsequently, the method 200 proceeds to the step 220. On the contrary, if the personal computer 120 does not detect that the mobile device 130 is electrically coupled to the personal computer 120 through the second port 122, the method 200 repeats the step 210.

In step 220, a second driver is installed in the personal computer 120 to substitute for the first driver to control the second port 122. For example, there is a software application installed in the personal computer 120. If the personal computer 120 detects that the mobile device 130 is electrically coupled to the personal computer 120 through the second port 122, the software application will automatically install the second driver to substitute for the first driver to control the second port 122.

In step 230, the personal computer 120 is configured to send a command to the mobile device 130 to make the personal computer 120 as an accessory device for the mobile device 130 based on the second OS system. For example, when the mobile device 130 firstly connects to the personal computer 120 through the second port 122, the mobile device 130 is regard as a slave (a MTP device), and the personal computer 120 is regard as a host based on the first OS system (i.e., Windows™ OS system). The step 230 is executed to change the authority among the personal computer 120 and the mobile device 130. After the mobile device 130 receives the command sent from the personal computer 120, the mobile device 130 is regard as a host, and the personal computer 120 is regard as a slave (Android Accessory) based on the second OS system (i.e., Android™OS system).

Subsequently, step 240 is executed to transfer the control right of the input device 110 from the personal computer 120 to the mobile device 130. For example, the mobile device 130 is now regard as the host based on the second OS system (i.e.,

Android OS system); and therefore, the control right of the input device 110 is transferred from the personal computer 120 to the mobile device 130.

In step 250, the first driver of the personal computer 120 is configured to get an input signal from the input device 110 through the first port 240. The second driver of the personal computer 120 converts the input signal, and sends the converted input signal to the mobile device 130 through the second port 122.

In some embodiments, the method 200 further includes step of: after the personal computer 120 detects that the mobile device 130 is electrically coupled to the personal computer 120 through the second port 122, the personal computer 120 further detects whether the mobile device 130 is removed from the personal computer 120 through the second port 122; if the personal computer 120 detects that the mobile device 130 is removed from the personal computer 120, the software application will automatically install the first driver to substitute for the second driver to control the second port 122; if the personal computer 120 does not detect that the mobile device 130 is removed from the personal computer 120, the personal computer 120 repeats the step of detecting whether the mobile device 130 is removed from the personal computer 120 through the second port 122.

In view of above, the method 200 can automatically transfer the control right of the input device 110 of the personal computer 120 to the mobile device 130. Hence, users can directly use the input device 110 to operate or input information into the mobile device 130 through the assistance of the personal computer 120, such that the problem that the mobile device 130 is hard for users to input information is solved.

Although the personal computer 120 and the mobile device 130 may use different OS systems, after automatically transferring the control right of the input device 110, the personal computer 120 can functionally change the format of the input signal generated from the input device 110 into proper format for the mobile device 130. Therefore, users can directly use the input device 110 of the personal computer 120 to operate the mobile device 130 without any additional manual operations.

Further, as may be appreciated by persons having ordinary skill in the art, the steps of the method 200 are named according to the function they perform, and such naming is provided to facilitate the understanding of the present disclosure but not to limit the steps. Combining the step into a single step or dividing any one of the steps into multiple steps, or switching any step so as to be a part of another step falls within the scope of the embodiments of the present disclosure.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for automatically functionally transferring an input device of a personal computer to a mobile device, wherein the personal computer is based on a first OS system and has a plurality of ports actuated by a first driver in the personal computer, wherein at least one of the ports, as a first port, is adapted to electrically couple the input device, wherein the mobile device is based on a second OS system, the method comprising the steps of:
(a) detecting whether the mobile device is electrically coupled to the personal computer through one of the ports, as a second port, to proceed to step (b) if the mobile device is electrically coupled to the personal computer, or to repeat step (a) if the mobile device is not electrically coupled to the personal computer;
(b) installing a second driver in the personal computer to substitute for the first driver to control the second port;
(c) sending a command to the mobile device to make the personal computer as an accessory device for the mobile device based on the second OS system;
(d) transferring the control right of the input device from the personal computer to the mobile device; and
(e) getting an input signal from the input device through the first port and the first driver, converting the input signal through the second driver, and sending the converted input signal to the mobile device through the second port.

2. The method of claim 1, wherein the mobile device supports Android Open Accessory.

3. The method of claim 1, wherein the input device comprises a keyboard, a mouse or a touch pad.

4. The method of claim 1, wherein the first OS system comprises a Windows system and the second OS system includes an Android system.

5. The method of claim 1, wherein the ports comprise USB ports.

6. The method of claim 1, wherein the first driver comprises a standard USB driver.

7. The method of claim 1, wherein the mobile device comprises a smartphone or a tablet.

8. The method of claim 1, wherein the personal computer is installed a software application comprising the second driver.

9. The method of claim 8, wherein the step (b) comprising: installing the second driver in the personal computer by the software application to substitute for the first driver to control the second port.

10. The method of claim 9, further comprising the steps of:
(f) after the personal computer detects that the mobile device is electrically coupled to the personal computer through the second port, the personal computer further detects whether the mobile device is removed from the personal computer through the second port to proceed to step (g) if the mobile device is removed from the personal computer, or to repeat step (f) if the mobile device is electrically coupled to the personal computer; and
(g) installing the first driver to substitute for the second driver to control the second port by the software application.
